(19) United States
(12) Patent Application Publication
(10) Pub. No.: US 2007/0108249 A1
(43) Pub. Date: May 17, 2007

(54) Motor control for combustion nailer based on operating mode

(76) Inventor: Larry M. Moeller, Schaumburg, IL (US)

Correspondence Address: LISA M. SOLTIS;ILLINOIS TOOL WORKS INC., 3600 WEST LAKE AVENUE, GLENVIEW, IL, 60026, US

(21) Appl. No.: 11/391,037

(22) Filed: Mar. 28, 2006

Related U.S. Application Data
(60) Provisional application No. 60/737,681, filed on Nov. 17, 2005.

(51) Int. Cl. B25C 1/14

(52) U.S. Cl. 227/10

(57) ABSTRACT

A combustion nailer configured for selectively operating in one of a sequential and a repetitive mode includes a combustion engine at least in part defining a combustion chamber, a fan motor associated with the combustion chamber and a control system for controlling operation of the nailer, the control system being configured for powering the fan motor at a first speed when the nailer is operating in the sequential mode, and a second speed when the nailer is operating in the repetitive mode.

### RELATED APPLICATION

The present application claims priority under 35 USC §120 from U.S. Ser. No. 60/737,681 filed Nov. 17, 2005.

### BACKGROUND

The present invention relates generally to fastener-driving tools used for driving fasteners into workpieces, and specifically to combustion-powered fastener-driving tools, also referred to as combustion tools or combustion nailers.

Combustion-powered nailers are known in the art for driving fasteners into workpieces, and examples are described in commonly assigned patents to Nikolich U.S. Pat. Re. No. 32,452, and U.S. Pat. Nos. 4,522,162; 4,483,473; 4,483,474; 4,403,722; 5,197,646; 5,263,439 and 5,713,313, all of which are incorporated by reference herein. Similar combustion-powered nail and staple driving tools are available commercially from ITW-Paslode of Vernon Hills, Ill. under the IMPULSE® and PASLODE® brands.

Such nailers incorporate a housing enclosing a small internal combustion engine or power source. The engine is powered by a canister of pressurized fuel gas, also called a fuel cell. A battery-powered electronic power distribution unit produces a spark for ignition, and a fan located in a combustion chamber provides for both an efficient combustion within the chamber, while facilitating processes ancillary to the combustion operation of the device. Such ancillary processes include: mixing the fuel and air within the chamber, turbulence to increase the combustion process, scavenging combustion by-products with fresh air, and cooling the engine. The engine includes a reciprocating piston with an elongated, rigid driver blade disposed within a cylinder body.

A valve sleeve is axially reciprocable about the cylinder and, through a linkage, moves to close the combustion chamber when a work contact element at the end of the linkage is pressed against a workpiece. This pressing action also triggers a fuel-metering valve to introduce a specified volume of fuel into the closed combustion chamber.

Upon the pulling of a trigger switch, which causes the spark to ignite a charge of gas in the combustion chamber of the engine, the combined piston and driver blade is forced downward to impact a positioned fastener and drive it into the workpiece. The piston then returns to its original or pre-firing position, through differential gas pressures created by cooling of residual combustion gases within the cylinder. Fasteners are fed magazine-style into the nosepiece, where they are held in a properly positioned orientation for receiving the impact of the driver blade.

Nailers of the type described above are operated in sequential or repetitive firing modes (also referred to as sequential or repetitive modes), each of which places unique operating demands on the engine or combustion power source. In the case of the sequential mode, the fastening operation requires deliberate action by the operator to position and operate the tool. This in turn affords more time for the engine operational events to be performed. Such events include valve sleeve closing, fan motor start and acceleration, fuel injection, fuel mixing, ignition, combustion and drive cycles, piston return, valve sleeve opening, and scavenging and replacement of spent gases with a fresh charge of air. With the necessary time provided for full process completion, repeatable nailer performance is achieved.

In the case of the repetitive firing mode, the time for the cycle operations is significantly reduced, which can lead to erratic nailer operation. This can be the result of poor fuel/air mixtures due to improper scavenging of spent gases, not enough mixing time, and/or insufficient turbulence for effecting combustion.

Thus, there is a need for improving the cycle operation of combustion nailers depending on nailer operating modes.

### BRIEF SUMMARY OF THE INVENTION

The above-listed need is met or exceeded by the present motor control for a combustion nailer based on operating mode which features a control system that provides fan motor performance in accordance with an associated nailer operating mode. When the nailer is operated in a sequential fire mode, the motor operating parameters are distinct from those during a repetitive fire operating mode. More specifically, in the preferred embodiment, the present control system powers ON the fan when the repetitive fire mode is activated. The activation is accomplished by manipulating the operating switches of the tool, such as combinations of trigger or chamber/head switch activations. Alternatively, the activation may be accomplished with a manually operated switch. The powering ON of the motor with the onset of the repetitive fire operating mode allows the motor time to accelerate to operating RPM and promote rapid fuel/air mixing in preparation for the first intended operation. Another aspect of the present control system is that the fan motor is operated at higher RPM under repetitive fire operating mode than under the sequential fire operating mode.

More specifically, a combustion nailer configured for selectively operating in one of a sequential and a repetitive mode includes a combustion engine at least in part defining a combustion chamber, a fan motor associated with the combustion chamber and a control system for controlling operation of the nailer, the control system being configured for powering the fan motor at a first speed when the nailer is operating in the sequential mode, and a second speed when the nailer is operating in the repetitive mode.

### BRIEF DESCRIPTION OF THE SEVERAL VIEWS OF THE DRAWINGS

FIG. 1 is a front perspective view of a fastener-driving tool incorporating the present fan motor control system; and

FIG. 2 is a fragmentary vertical cross-section of the tool of FIG. 1 shown in the rest position.

### DETAILED DESCRIPTION OF THE INVENTION

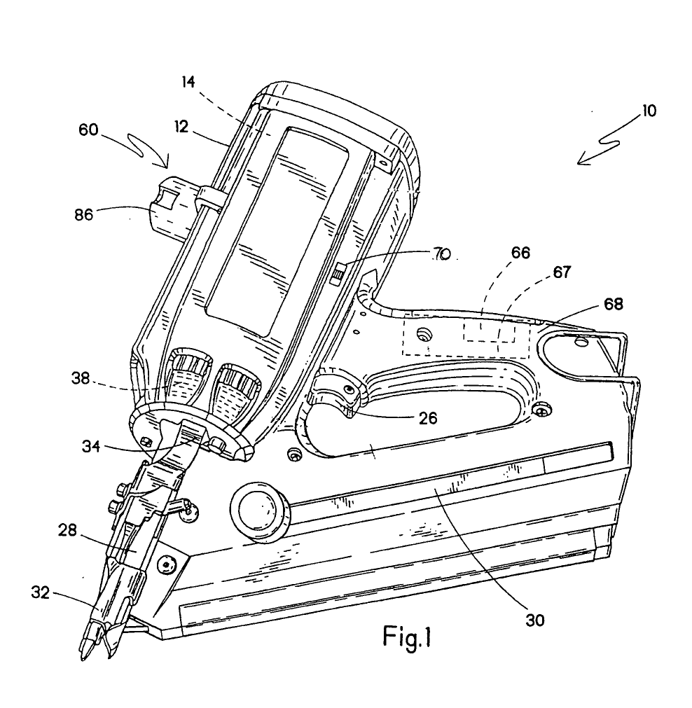

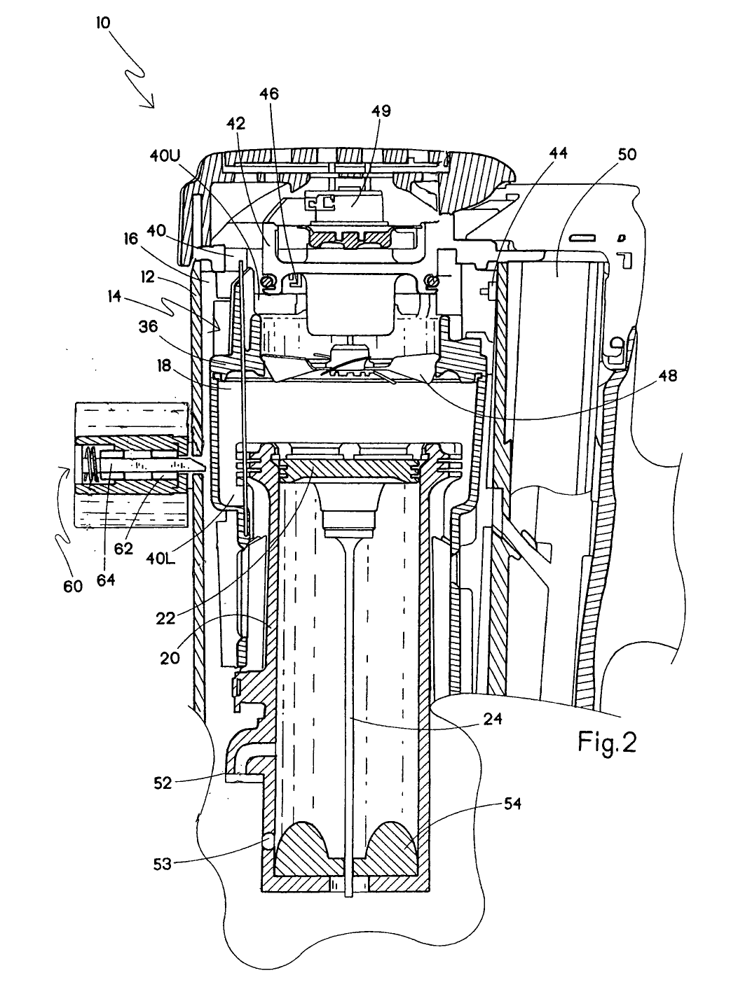

Referring now to FIGS. 1 and 2, a combustion-powered fastener-driving tool, also known as a combustion nailer, incorporating the present control system is generally designated 10 and preferably is of the general type described in detail in the patents listed above and incorporated by reference in the present application. A housing 12 of the tool 10 encloses a self-contained internal power source 14 (FIG. 2) within a housing main chamber 16. As in conventional combustion tools, the power source or combustion engine 14 is powered by internal combustion and includes a combustion chamber 18 that communicates with a cylinder 20. A piston 22 reciprocally disposed within the cylinder 20 is connected to the upper end of a driver blade 24. As shown in FIG. 2, an upper limit of the reciprocal travel of the piston 22 is referred to as a pre-firing position, which occurs just prior to firing, where ignition of the combustion gases initiates the downward driving of the driver blade 24 to impact a fastener (not shown).

Depending on the selected operational mode, when the nailer 10 is in a sequential mode, through depression of a trigger 26 associated with a trigger switch (not shown, the terms trigger and trigger switch are used here interchangeably), an operator induces combustion within the combustion chamber 18, causing the driver blade 24 to be forcefully driven downward through a nosepiece 28 (FIG. 1). The nosepiece 28 guides the driver blade 24 to strike a fastener that had been delivered into the nosepiece via a fastener magazine 30.

Adjacent to the nosepiece 28 is a workpiece contact element 32, which is connected, through a linkage 34 to a reciprocating valve sleeve 36, an upper end of which partially defines the combustion chamber 18. Depression of the tool housing 12 against the workpiece contact element 32 in a downward direction as seen in FIG. 1 (other operational orientations are contemplated as are known in the art), causes the workpiece contact element to move from a rest position to a pre-firing position. This movement overcomes the normally downward biased orientation of the workpiece contact element 32 caused by a spring 38 (shown hidden in FIG. 1). Other locations for the spring 38 are contemplated.

Through the linkage 34, the workpiece contact element 32 is connected to and reciprocally moves with, the valve sleeve 36. In the rest position (FIG. 2), the combustion chamber 18 is not sealed, since there is an annular gap 40 including an upper gap 40U separating the valve sleeve 36 and a cylinder head 42, which accommodates a spark plug 46, and a lower gap 40L separating the valve sleeve 36 and the cylinder 20. A chamber switch 44 is located in proximity to the valve sleeve 36 to monitor its positioning. In the preferred embodiment of the present tool 10, the cylinder head 42 also is the mounting point for at least one cooling fan 48 and an associated fan motor 49 which extends into the combustion chamber 18 as is known in the art and described in the patents which have been incorporated by reference above. In the rest position depicted in FIG. 2, the tool 10 is disabled from firing because the combustion chamber 18 is not sealed between the cylinder head 42 and the cylinder 20, and the chamber switch 44 is open.

Firing is enabled when an operator presses the workpiece contact element 32 against a workpiece. This action overcomes the biasing force of the spring 38, causes the valve sleeve 36 to move upward relative to the housing 12, closing the gaps 40U and 40L, sealing the combustion chamber 18 and activating the chamber switch 44. This action also induces a measured amount of fuel to be released into the combustion chamber 18 from a fuel canister 50 (shown in fragment).

In the sequential operating mode, upon pulling the trigger 26, the spark plug 46 is energized, igniting the fuel and air mixture in the combustion chamber 18 and sending the piston 22 and the driver blade 24 downward toward the waiting fastener for entry into the workpiece. In an alternative mode of operation known as repetitive firing, ignition is initiated by the closing of the chamber switch 44, since the trigger 26 has already been pulled and the corresponding switch closed. As the piston 22 travels down the cylinder 20, it pushes a rush of air which is exhausted through at least one petal, reed or check valve 52 and at least one vent hole 53 located beyond the piston displacement (FIG. 2). At the bottom of the piston stroke or the maximum piston travel distance, the piston 22 impacts a resilient bumper 54 as is known in the art. With the piston 22 beyond the exhaust check valve 52, high pressure gasses vent from the cylinder 20. Due to cooling of the residual gases, internal pressure differentials created in the cylinder 20 cause the piston 22 to be forced back to the pre-firing position shown in FIG. 2.

Referring now to FIGS. 1 and 2, to accommodate these design concerns, the present tool 10 preferably incorporates a combustion chamber control device, generally designated 60 and configured for preventing the reciprocation of the valve sleeve 36 from the closed or firing position until the piston 22 returns to the pre-firing position. This holding or locking function of the control device 60 is operational for at least the minimum period of time required for the piston 22 to return to the pre-firing position. Thus, the operator using the tool 10 in a repetitive cycle mode can lift the tool from the workpiece where a fastener was just driven, and begin to reposition the tool for the next firing cycle. Due to the shorter firing cycle times inherent with repetitive cycle operation, the lockout device 60 ensures that the combustion chamber 18 will remain sealed during tool repositioning, and the differential gas pressures maintained so that the piston 22 will be returned before premature opening of the chamber 18, which would interrupt piston return. It should be understood that the lockout device 60 as shown is only exemplary of many types of similar devices which could be used to perform the same function.

More specifically, and referring to FIG. 2, the combustion chamber control device 60 includes an electromagnet 62 configured for engaging a latch 64 which transversely reciprocates relative to the valve sleeve 36 for preventing the movement of the valve sleeve for a specified amount of time. This time period is controlled by a control program 66 (FIG. 1) embodied in a central processing unit or control module 67 (shown hidden), typically housed in a handle portion 68 (FIG. 1) of the housing 12. The control program 66, the CPU 67 and the associated wiring and components is collectively referred to as the control system.

From copending U.S. patent application Ser. No. 11/028,450 filed Jan. 3, 2005, which is incorporated by reference, it is contemplated to configure the control system so that the user can select between sequential mode and repetitive mode operation by manipulation of the trigger 26 and/or the chamber switch 44. More specifically, if the nailer is operated so that the chamber switch 44 is closed before the trigger 26, the nailer 10 will operate in sequential mode. Alternatively, if the trigger 26 is activated or pulled and released in a specified pattern, for example two trigger operations within 500 msec, and thereafter held activated with the chamber switch 44 open, the nailer is selected to operate in the repetitive mode of operation.

As described in greater detail in copending application Ser. No. 11/028,450, the tool 10 is default set to operate in sequential-fire mode and operate as is commonly known in the art in view of the patents incorporated by reference herein. The operational cycle begins with the valve sleeve 36 and the workpiece contact element 32 in the rest position, and the trigger 26 released. In this condition, all tool functions are inactive. To switch the nailer 10 into a firing mode (either sequential or repetitive cycle), the program 66 monitors switch activity—nothing occurs until one of the switches is closed. If the chamber switch 44 is closed upon the start of a user initiated operational cycle, the subsequent pulling of the trigger 26 will result in a sequential operation of the nailer engine. If the chamber switch 44 is released prior to the pulling of the trigger 26, no operations related to the combustion cycle occur, the program 66 resumes monitoring the switches.

Alternately, if the chamber switch 44 is open and the trigger 26 is closed or pulled, the control program 66 looks for requirements to begin and maintain repetitive cycle operation. Specifically, an important feature of the control program 66 is that the trigger 26 needs to be fully closed, fully released, and fully closed again all within 500 msec to put the tool 10 into the repetitive cycle mode. Thereafter, to maintain repetitive cycle operation the trigger 26 must remain depressed or pulled to maintain the repetitive cycle mode once that mode has been selected. If during the repetitive cycle, no chamber activity occurs within preset time, such as 5 seconds, the program 66 discontinues that mode of operation and resumes operation after all the chamber switch 44 and trigger 26 are opened.

As an alternative to the automatic selection of operational modes depending on the condition of the chamber switch 44 or the trigger 26, it is also contemplated that an external switch 70 (FIG. 1) be provided that is connected to the control program 66. The switch 70 may be user activated to control the operational mode (sequential/repetitive) of the nailer 10.

An important feature of the present nailer 10 is that the control system is configured so that the fan motor 49 is powered ON with the onset of the repetitive operating mode. This feature allows the motor time to accelerate to operating RPM and to promote rapid fuel/air mixing in preparation for the first intended operation.

An additional feature is for the motor 49 to operate the fan RPM at a different speed during repetitive cycle operation than in sequential operation. More specifically, the control program 66 operates the fan motor 49 at a higher speed during repetitive fire than in sequential mode. This is because during repetitive operation, cycle interval times are reduced and the increased fan motor RPM will compensate for the reduction. Also, higher fan motor RPM will reduce fuel/air mixing times and any consequential ignition delays. Further, the scavenging of spent gases and replacement with a fresh air charge will occur in less time. Lastly, the increased RPM produces more cooling air flow (CFM) through the nailer 10 to keep tool operating temperatures at acceptable levels. This compensates for the increase heating effect of the engine that can occur during rapid and recurrent nailer operations.

The fan motor RPM ranges of interest are in the general range of 10,000-12,000 for sequential fire operation, and 12,000-15,000 for repetitive operation. In the preferred embodiment, the control system operates the fan motor RPM at a relatively fixed 10,500 RPM for sequential operation, and 13,000 RPM for repetitive operation. However, it will be appreciated that these values, as well as the above RPM ranges, may vary to suit the application, the particular nailer, or the desired operating conditions of the nailer. It is contemplated that the fan motor speed in repetitive cycle operation is approximately 20-50% faster than in sequential fire mode.

Although both modes can operate at the higher values associated with repetitive cycling, such operation is not preferred since excessive battery consumption, increased dirt intake and increased motor component wear will result.

Thus, it will be seen that the present nailer includes an improved control system which provides differentiated fan motor operating parameters for each nailer operational mode. The present motor control enhances repeatable nailer performance and compensates for the operational demands of repetitive cycle operation including scavenging of spent gases, and reduced engine operating temperatures.

While particular embodiments of the present motor control based on operating mode for a combustion nailer has been described herein, it will be appreciated by those skilled in the art that changes and modifications may be made thereto without departing from the invention in its broader aspects and as set forth in the following claims.

1. A combustion nailer configured for selectively operating in one of a sequential and a repetitive mode, comprising:
a combustion engine at least in part defining a combustion chamber, and a fan motor associated with said combustion chamber;
a control system for controlling operation of the nailer, said control system being configured for powering said fan motor at a first speed when said nailer is operating in the sequential mode, and a second speed when said nailer is operating in the repetitive mode.

2. The combustion nailer of claim 1 wherein said first speed is slower than said second speed.

3. The combustion nailer of claim 1 wherein said nailer is selected for operation between sequential and repetitive operation by an external switch.

4. The combustion nailer of claim 1 wherein said nailer is selected for operation between sequential and repetitive operation by a sequence of activating conventional tool functions.

5. The combustion nailer of claim 4 wherein said tool functions incorporate manipulation of at least one of trigger switch activation and chamber switch activation.

6. The combustion nailer of claim 1 wherein said second speed is approximately 20-50% faster than said first speed.

7. The combustion nailer of claim 1 wherein said first speed is in the general range of 10,000-12,000 RPM and said second speed is in the general range of 12,000-15,000 RPM.

8. The combustion nailer of claim 7 wherein said preferred first speed is 10,500 RPM and said preferred second speed is 13,000 RPM.

9. A combustion nailer configured for selectively operating in one of a sequential and a repetitive mode, comprising:
a combustion engine at least in part defining a combustion chamber, and an associated fan motor associated with said combustion engine so that a fan powered by said motor projects into said combustion chamber;
a control system for controlling operation of said nailer, said control system being configured for user selection of operation in one of said sequential and said repetitive mode, said system also configured so that, upon selecting said repetitive mode, said fan motor is powered ON.

10. The combustion nailer of claim 9 wherein said control system is configured so that said fan motor is powered at a relatively slower speed when said nailer is operating in the sequential mode, and at a relatively faster speed when said nailer is operating in the repetitive mode.
